(19) United States
(12) Patent Application Publication
(10) Pub. No.: US 2010/0327146 A1
(43) Pub. Date: Dec. 30, 2010

(54) MOLD

(75) Inventor: HSI-CHANG WU, Tu-Cheng (TW)

Correspondence Address: Altis Law Group, Inc.;ATTN: Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/694,186

(22) Filed: Jan. 26, 2010

(30) Foreign Application Priority Data
Jun. 26, 2009 (CN) 200910303721.9

(51) Int. Cl. B29C 39/26

(52) U.S. Cl. 249/187.1

(57) ABSTRACT

A mold comprises a first molding plate and a second molding plate. A wedge-shaped mold cavity and an entrance connecting to the wedge-shaped mold cavity are defined in the second molding plate. The wedge-shaped mold cavity comprises a pouring end surface, a first side end surface and a second side end surface connecting to two ends of the pouring end surface respectively. The entrance comprises a first sidewall adjacent to the first side end surface, and a second sidewall slantingly opposite to the second side end surface.

### BACKGROUND

1. Technical Field

The present disclosure relates to a mold.

2. Description of Related Art

In general, a light guide plate has a thin side and a thick side. When molding the light guide plate, firstly fill the thin side, and secondly fill the thick side. However, when filling the thick side, the thin side starts to harden and consequently leads the light guide plate to warp, and results in a deformation in size.

Therefore, what is needed is a mold to overcome the shortcoming described.

### BRIEF DESCRIPTION OF THE DRAWINGS

FIG. 1 is a cross-sectional view of a mold in accordance with an exemplary embodiment.

FIG. 2 is a schematic, top plan view diagram of the mold of FIG. 1, showing a part of the mold.

FIG. 3 is a schematic diagram of a roughcast of a light guide plate in accordance with an exemplary embodiment.

FIG. 4 is a parsing diagram of the thickness of the roughcast of the light guide plate molded using the mold of FIG. 3.

FIG. 5 is a parsing diagram of the thickness of the roughcast of the light guide plate molded using a conventional mold.

### DETAILED DESCRIPTION

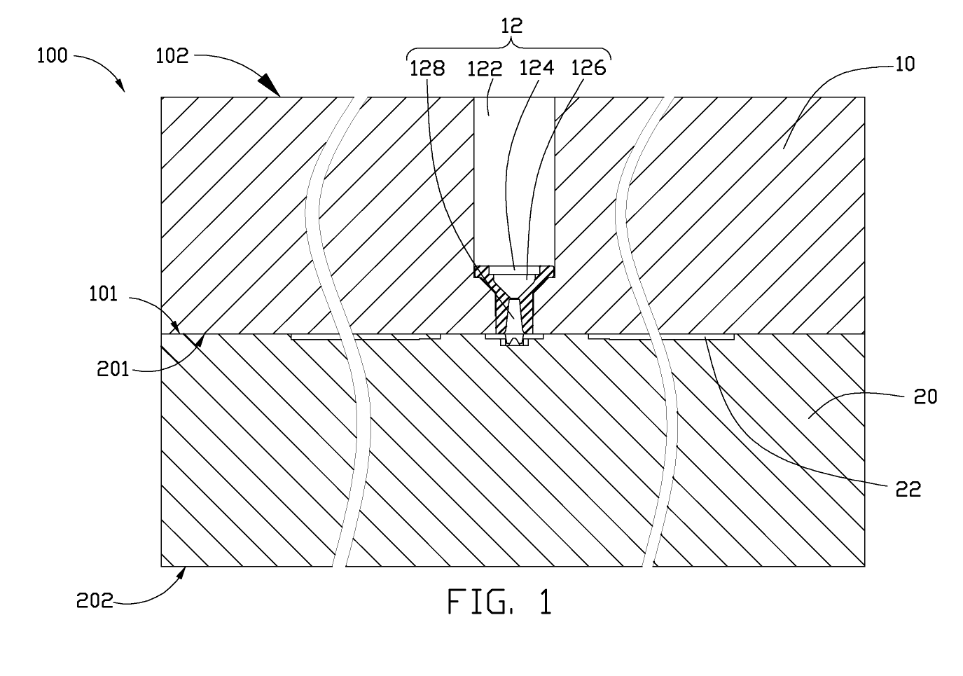

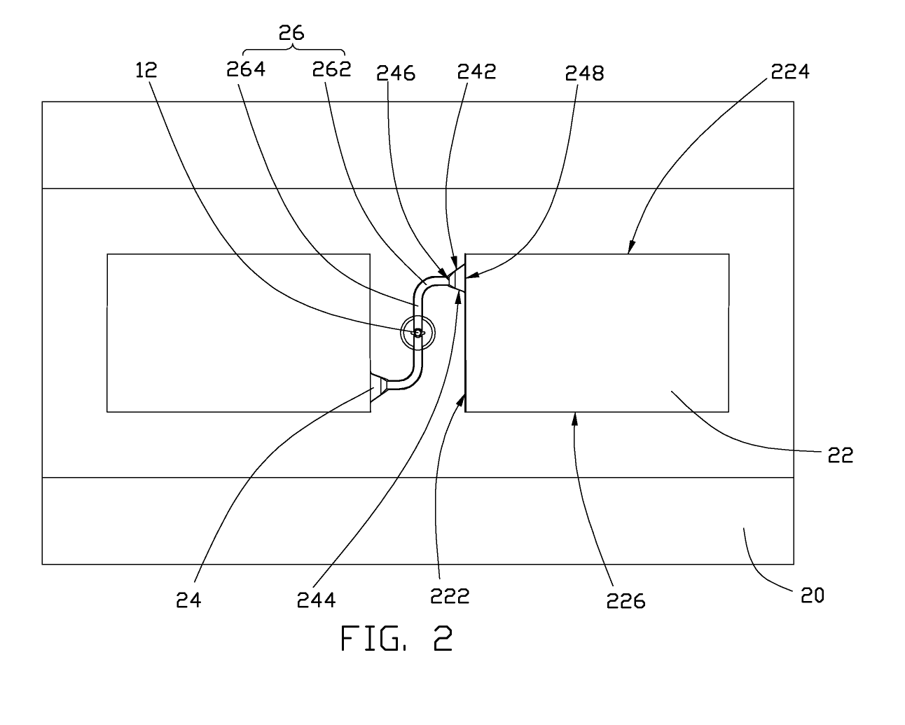

Referring to FIGS. 1-2, a mold 100 is provided. The mold 100 includes a first molding plate 10 and a second molding plate 20.

The first molding plate 10 includes a first surface 101 and a second surface 102 opposite to the first surface 101. The first surface 101 is symmetrical to the second molding plate 20, and the second surface 102 is away from the second molding plate 20. A runner 12 is defined in the first molding plate 10 for pouring of molten plastic in the mold 100.

In the exemplary embodiment, the runner 12 includes a first segment 122, a second segment 124 connecting to the first segment 122, a third segment 126 connecting to the second segment 124, and a fourth segment 128 connecting to the third segment 126 in turn. The first segment 122 is defined at one end of the runner 12 adjacent to the second surface 102, and is configured for connecting to a feeding device (not shown). The diameter of the second segment 124 is less than that of the first segment 122. The second segment 124 is configured for making a buffer for the molten or liquefied plastic flowing from the first segment 122. The third segment 126 is connected between the second segment 124 and the fourth segment 128. The third segment 126 is generally cone-shaped and the diameter of it is less than that of the second segment 124. The diameter of the third segment 126 narrows in a direction from the second surface 102 to the first surface 101 so that pressure built up urges the molten or liquefied plastic to the fourth segment 128. The fourth segment 128 is extended through the first surface 101. The diameter of the fourth segment 128 is also less than that of the second segment 124. The diameter of the fourth segment 128 increases in a direction from the second surface 102 to the first surface 101, so that during demoulding, a junction in the molded plastic between the third segment 126 and the fourth segment 128 easily breaks. The junction between the third segment 126 and the fourth segment 128 is also configured for preventing contaminants from entering the mold 100.

The second molding plate 20 includes a first surface 201 and a second surface 202 opposite to the first surface 201. The first surface 201 is opposite to the first molding plate 10, and the second surface 202 is away from the first molding plate 10. A wedge-shaped mold cavity 22, an entrance 24 connecting to the wedge-shaped mold cavity 22, and an tube 26 connecting between the entrance 24 and the runner 12 are defined towards to the inside of the first surface 201 of the second molding plate 20.

The wedge-shaped mold cavity 22 includes a pouring end surface 222 connecting to the entrance 24, a first side end surface 224 and a second side end surface 226 connecting to two opposite ends of the pouring end surface 222 respectively. The depth of the wedge-shaped mold cavity 22 located in the first side end surface 224 exceeds the depth of the wedge-shaped mold cavity 22 located in the second side end surface 226. That is, the distance between a bottom surface of the wedge-shaped mold cavity 22 located in the first side end surface 224 and the first surface 201 exceeds the distance between the bottom surface of the wedge-shaped mold cavity 22 located in the second side end surface 226 and the first surface 201. In the exemplary embodiment, the first side end surface 224 and the second side end surface 226 are vertical to the pouring end surface 222.

The distance between the entrance 24 and the first side end surface 224 is less than the distance between the entrance 24 and the second side end surface 226. That is, the entrance 24 is not set in a middle position of the pouring end surface 222.

In the exemplary embodiment, a section of the entrance 24 is trapeziform shaped. The entrance 24 includes a first sidewall 242 adjacent to the first side end surface 224 and a second sidewall 244 slantingly opposite to the first sidewall 242. An angle formed by the first sidewall 242 and the pouring end surface 222 is less than the angle formed by the second sidewall 244 and the pouring end surface 222. In the exemplary embodiment, the range of the difference between the angle formed by the second sidewall 244 and the pouring end surface 222 and the angle formed by the first sidewall 242 and the pouring end surface 222 is from 5 about degrees to about 45 degrees. Because the entrance 24 is adjacent to the first side end surface 224, and the angle between the first sidewall 242 to the pouring end surface 222 is less than the angle between the second sidewall 244 to the pouring end surface 222, the molten or liquefied plastic is easily poured into the first side end surface 224, so that, the flow rate of the molten or liquefied plastic pouring into the first side end surface 224 is consistent with the flow rate of the molten or liquefied plastic pouring into the second side end surface 226.

The entrance 24 includes a first port 246 and a second port 248. The first port 246 and the second port 248 are located in two parallel sides of the entrance 24. The caliber of the first port 246 is less than that of the second port 248. The first port 246 is connected to the tube 26, and the second port 248 is connected to the pouring end surface 222.

The tube 26 includes a first curved portion 262 and a second curve portion 264 connecting to the first curved portion 262. The second curved portion 264 is connected to the runner 12, and the first curved portion 262 is connected to the entrance 24. The molten or liquefied plastic flow into the first curved portion 262, the second curved portion 264, and then flow into the first port 246 and the second port 248 by the entrance 24, and the caliber increases in a direction from the first port 246 to the second port 248, so that, the impact force from the molten or liquefied plastic is dispersed along the entrance 24, and the molten or liquefied plastic is uniformly poured into the wedge-shaped mold cavity 22. In the embodiment, there are two cavities 22 defined in the second molding plate 20 with the same profile.

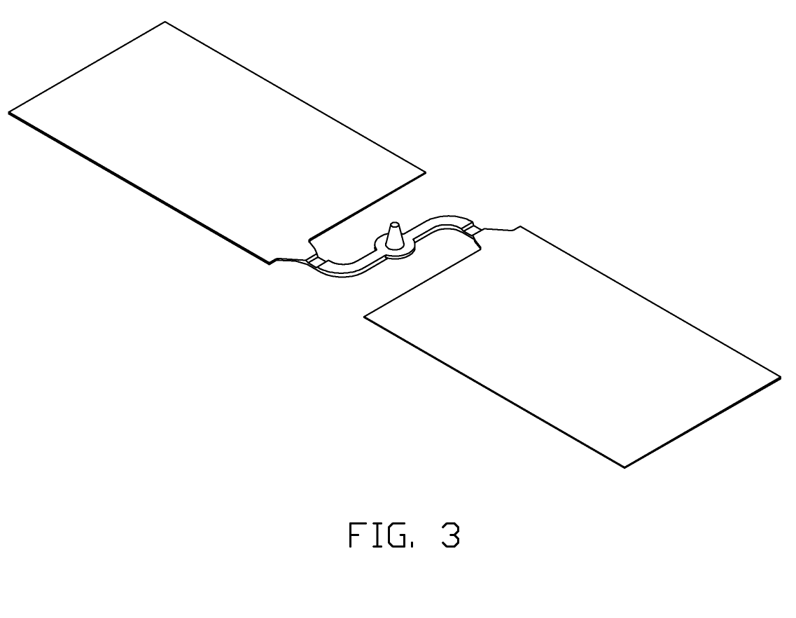

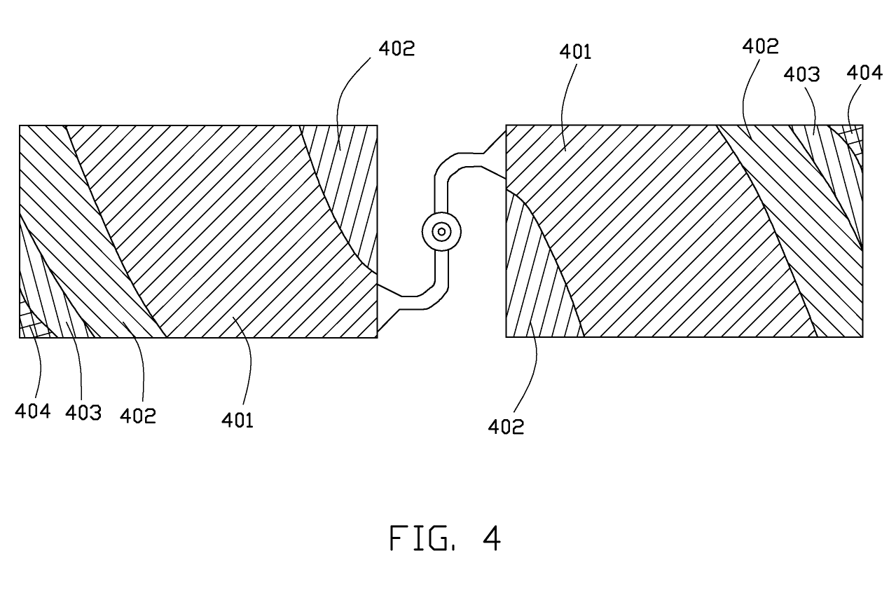

Referring to FIG. 3, a roughcast (not labeled) of a light guide plate (not labeled) is molded by the mold 100 in the exemplary embodiment, and is parsed to produce an error-parsing diagram as shown in FIG. 4. The thickness error of the roughcast can be found in four areas, namely, a first area 401, a second area 402, a third area 403, and a fourth area 404. The range of the thickness error in the first area 401 is from 0.4671 mm to 0.9213 mm; the range of the thickness error in the second area 402 is from 0.9213 mm to 1.375 mm; the range of the thickness error in the third area 403 is from 1.375 mm to 1.830 mm, and the range of the thickness error in the fourth area 404 is from 1.830 mm to 2.284 mm.

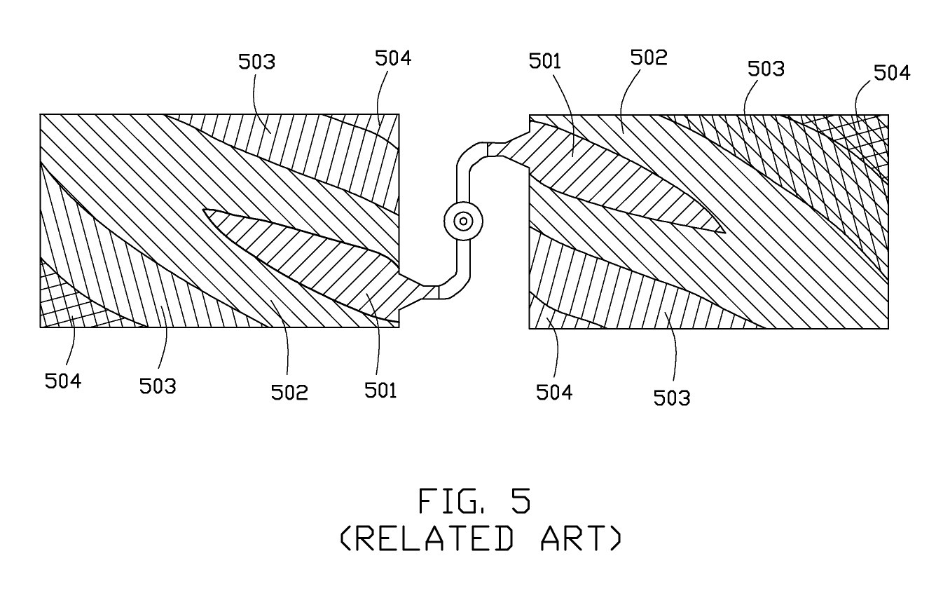

Referring to FIG. 5, a roughcast of a light guide plate is molded by the conventional mold, and is parsed to produce an error parsing diagram. The thickness error of the roughcast can also be found in four areas, namely, a first areas 501, a second areas 502, a third area 503 and a fourth area 504. The range of the thickness error in the first area 501 is from 0.0189 mm to 0.7602 mm; the range of the thickness error in the second area 502 is from 0.7602 mm to 1.502 mm; the range of the thickness error in the third area 503 is from 1.502 mm to 2.243 mm and the range of the thickness error in the fourth area 504 is from 2.243 mm to 2.984 mm.

As described above, the range of the thickness error of the roughcast of the light guide plate molded by the mold 100 in the exemplary embodiment is from 0.4671 mm to 1.375 mm, and the range of the thickness error of the roughcast of the light guide plate molded by the conventional mold in is from 0.7602 mm to 2.243 mm. Accordingly, the mold 100 in the exemplary embodiment has relatively smaller errors in the light guide plate, and improves size uniformity of the light guide plate.

Although the present disclosure has been specifically described on the basis of the embodiments thereof, the disclosure is not to be construed as being limited thereto. Various changes or modifications may be made to the embodiments without departing from the scope and spirit of the disclosure.

What is claimed is:

1. A mold comprising:
a first molding plate;
a second molding plate cooperating with the first molding plate;
wherein a wedge-shaped mold cavity and an entrance connecting to the wedge-shaped mold cavity are defined in the second molding plate;
wherein, the wedge-shaped mold cavity comprises a pouring end surface, a first side end surface and a second side end surface connecting to two ends of the pouring end surface respectively;
wherein, the depth of the wedge-shaped mold cavity located in the first side end surface exceeds that of the wedge-shaped mold cavity located in the second side end surface; and the distance between the entrance and the first side end surface is less than that between the entrance and the second first side end surface;
wherein the entrance comprises a first sidewall adjacent to the first side end surface, and a second sidewall slantingly opposite to the second side end surface; and
wherein the angle formed by the first sidewall and the pouring end surface is less than that formed by the second sidewall and the pouring end surface.

2. The mold as described in claim 1, wherein the range of the difference between the angle formed by the second sidewall and the pouring end surface and that formed by the first sidewall and the pouring end surface is from about 5 degrees to about 45 degrees.

3. The mold as described in claim 1, wherein the first molding plate further comprises a first surface contacting the second molding plate and a second surface opposite to the first surface, a section of the entrance is trapeziform shaped and connects the pouring end surface.

4. The mold as described in claim 3, wherein the second sidewall is slantingly opposite to the first sidewall.

5. The mold as described in claim 3, wherein the entrance further comprises a first port and a second port opposite to the first port, the first port and the second port are located in two parallel sides of the entrance, and the second port is connected to the pouring end surface.

6. The mold as described in claim 5, wherein the caliber of the first port is less than that of the second port.

7. The mold as described in claim 5, further comprising a tube connected to the entrance, and the tube comprising a first curved portion and a second curved portion, wherein the second curved portion is connected to the entrance.

8. The mold as described in claim 7, further comprising a runner connected to the tube, wherein the runner comprises a first segment, a second segment, a third segment, and a fourth segment.

9. The mold as described in claim 8, wherein the diameter of the second segment is less than that of the first segment, and the diameter of the third segment and the fourth segment is less than that of the second segment respectively.

10. The mold as described in claim 8, wherein the diameter of the third segment narrows in a direction from the second surface to the first surface, and the diameter of the fourth segment increases in a direction from the second surface to the first surface.
